(19) United States
(12) Patent Application Publication
(10) Pub. No.: US 2025/0387962 A1
(43) Pub. Date: Dec. 25, 2025

(54) PRESSURE HOLDING DEVICE, INJECTION DEVICE, AND METHOD FOR INJECTING RESIN MATERIAL

(71) Applicant: NISSEI ASB MACHINE CO., LTD., Nagano (JP)

(72) Inventor: Hiroshi HORIGOME, Nagano (JP)

(73) Assignee: NISSEI ASB MACHINE CO., LTD., Nagano (JP)

(21) Appl. No.: 18/841,902

(22) PCT Filed: Feb. 28, 2023
(86) PCT No.: PCT/JP2023/007274

§ 371 Date: Apr. 14, 2025

(30) Foreign Application Priority Data
Feb. 28, 2022 (JP) 2022-028828

(51) Int. Cl. B29C 45/53; B29C 45/76

(52) U.S. Cl. CPC B29C 45/531; B29C 45/76

(57) ABSTRACT

A pressure holding device includes a stopper member that restricts a movement backward amount of a pressure holding plunger. When a pressure holding path is filled with a resin material, a second engagement member of the stopper member restricts the movement backward amount of the pressure holding plunger at a first position where the second engagement member is engaged with a first engagement member fixed to the pressure holding plunger. When a pressure of the mold is released after pressure holding, the second engagement member moves from the first position to a second position retracted from the first position to release a restriction on the movement backward amount of the pressure holding plunger.

### BACKGROUND OF THE INVENTION

### Field of the Invention

The present invention relates to a pressure holding device, an injection device, and a method for injecting a resin material.

### Description of the Related Art

Conventionally, in an injection device that performs injection molding of a resin material, a resin material metering step, a resin material injection filling step into a mold, and a pressure holding step are sequentially performed in this order.

In addition, there is also known an injection device provided with a pressure holding device including a plunger that moves back and forth independently of an injection screw (see, for example, JP 5535595 B2, JP 2928750 B2, JP 3352917 B2 and JP 2002-240114 A). In this type of injection device, it is possible to shorten a molding cycle of an injection molded article by executing the metering step with the injection screw while moving forth the plunger of the pressure holding device to hold the pressure of the injection molded article.

When the pressure holding step is completed, the pressure holding device stops pressurization of the resin, and moves back the plunger to perform pressure release (depressurization and decompression) of the resin. When pressure release of the resin is insufficient, defects such as nozzle clogging in a hot runner and cobwebbing (molding failure caused by insufficient solidification of a gate portion) at a gate portion (region corresponding to a gate hole of an injection cavity mold into which resin from the hot runner flows) of the molded article may occur.

The movement backward amount of the plunger of the pressure holding device at the time of pressure release greatly varies depending on the volume in a resin path of the hot runner. The volume in the resin path of the hot runner changes depending on a difference in a gate structure such as a valve gate type or an open gate type, specifications of the resin path according to the production amount of the injection molded article, and the like. In the case of performing pressure release on a hot runner having a large internal volume of a resin path, measures to increase the internal volume of the pressure holding path by increasing the size of the plunger or the like or lengthening the pressure holding path on the pressure holding device side can be considered.

However, if the internal volume of the pressure holding path is increased as described above by the pressure holding device that moves back the plunger in a free state at the time of injection and fills the pressure holding path with resin, the injection amount and the filling amount of the resin of the pressure holding device are wastefully increased, and the effect of shortening the molding cycle may be reduced. Furthermore, when the internal volume of the pressure holding path is increased, the pressure holding device also increases in size, which may lead to an increase in device cost.

In addition, if the amount of resin filled in the pressure holding path for pressure holding is inaccurate, molding conditions set for the injection device do not function well, and the quality of the manufactured injection molded article may be deteriorated.

### SUMMARY OF THE INVENTION

One aspect of the present invention is a pressure holding device that is attached to a pressure holding path branching from a resin path of an injection device and holds the resin path and the pressure holding path after injection of a resin material into a mold. A pressure holding device includes a pressure holding plunger including a first engagement member fixed to an outer periphery and moving forward and backward in a pressure holding path, a pressure holding piston that drives the pressure holding plunger, and a stopper member that restricts a movement backward amount of the pressure holding plunger. The stopper member includes a second engagement member that engages with the first engagement member, and a drive member that moves the second engagement member forward and backward in a direction intersecting a moving direction of the pressure holding plunger. When the pressure holding path is filled with the resin material, the second engagement member restricts the movement backward amount of the pressure holding plunger at a first position where the second engagement member is engaged with the first engagement member. When a pressure of the mold is released after pressure holding, the second engagement member moves from the first position to a second position retracted from the first position to release a restriction on the movement backward amount of the pressure holding plunger.

Further features of the present invention will become apparent from the following description of exemplary embodiments with reference to the attached drawings.

### BRIEF DESCRIPTION OF THE DRAWINGS

FIG. 1 is a view illustrating a state at start of injection in an injection device of the present embodiment.

FIG. 2 is a view illustrating a state before start of pressure holding in the injection device of the present embodiment.

FIG. 3 is a view illustrating a state of pressure release in the injection device of the present embodiment.

FIG. 4 is a view illustrating a resin discharge state of a pressure holding path in the injection device of the present embodiment.

FIG. 5 is a view illustrating a retracted state of a stopper member in the pressure holding device.

FIG. 6 is a view illustrating a protruding state of the stopper member in the pressure holding device.

FIG. 7 is a view illustrating a configuration example of the stopper member.

FIG. 8 is a view illustrating a molding flow in an injection molding apparatus including the injection device of the present embodiment.

FIGS. 9A and 9B are views illustrating a reinforcement mechanism of the pressure holding device.

FIG. 10 is a view illustrating an example of a molding device on which the pressure holding device is mounted.

FIG. 11 is a view illustrating an example of the molding device on which the pressure holding device is mounted.

FIG. 12 is a view illustrating an example of the molding device on which the pressure holding device is mounted.

### DESCRIPTION OF THE EMBODIMENTS

Hereinafter, embodiments of the present invention will be described with reference to the drawings.

In the embodiment, for easy understanding, structures and elements other than a main part of the present invention will be described in a simplified or omitted manner. Further, in the drawings, the same elements are denoted by the same reference numerals. Note that the shapes, dimensions, and the like of elements illustrated in the drawings are schematically illustrated, and do not indicate actual shapes, dimensions, and the like.

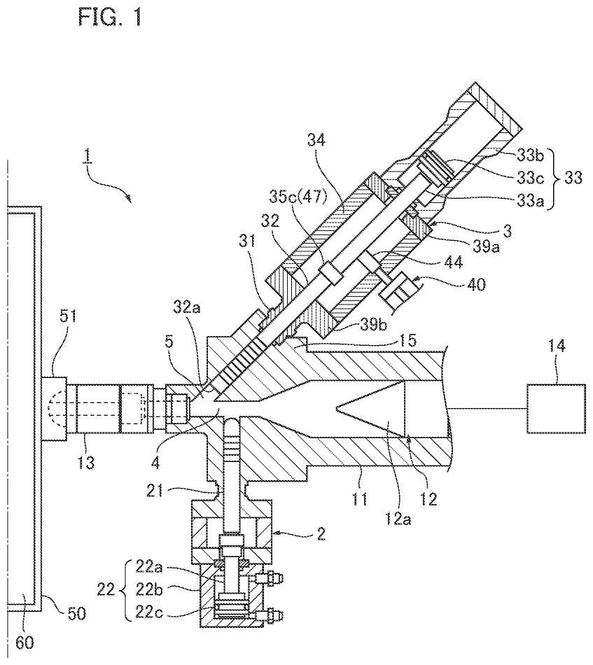

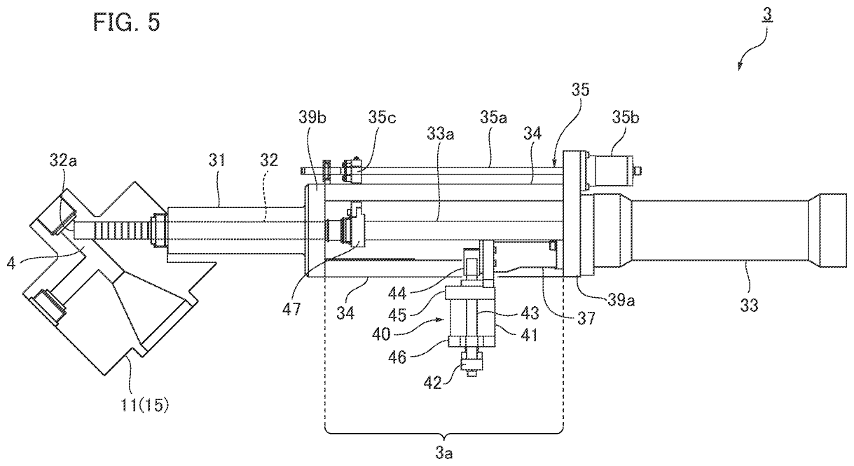

FIGS. 1 to 4 illustrate an example of an injection device 1 having a pressure holding device 3 of the present embodiment. FIGS. 5 to 7 illustrate an example of the pressure holding device 3 of the present embodiment.

The injection device 1 of the present embodiment is applied, for example, to supply a resin material to a mold of an injection molding apparatus that manufactures a bottomed cylindrical resin preform. The preform is applied to, for example, blow molding of a resin container. Although not particularly limited, the injection device 1 may be mounted on a hot-parison type (also referred to as a one-stage type) blow-molding apparatus that blow-molds a resin container by utilizing residual heat (internal heat quantity) from injection molding without cooling the preform to room temperature.

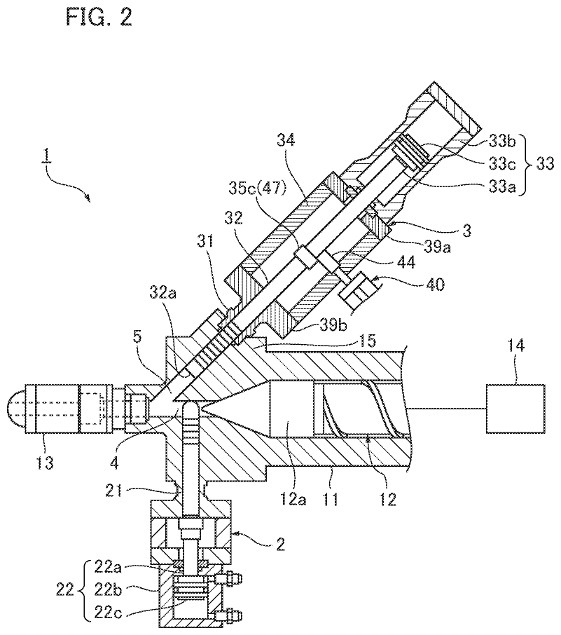

It is preferable that a hot runner is provided between the injection device 1 and the mold. In addition, the injection device 1 preferably has a configuration in which an injection nozzle (described later) abuts on a sprue (resin introduction port) 51 of a hot runner 50 and introduces a molten resin material into a cavity (molding space) of a mold (injection molding mold) 60 via a resin path in the hot runner 50. Note that, although the hot runner 50 and the mold 60 are omitted in FIGS. 2 to 6 and 9, the hot runner 50 and the mold 60 are provided in an arrangement similar to that in FIG. 1 also in these drawings.

As illustrated in FIGS. 1 to 4, the injection device 1 includes an injection cylinder 11, an injection screw 12, an injection nozzle 13, a drive cylinder (drive actuator) 14, a rotation mechanism (not illustrated), a shutoff device 2, and a pressure holding device 3. Note that a hopper that supplies a resin material, a drive device that rotates the injection screw 12, and the like, which are not illustrated, are provided on a rear side of the injection device 1 (opposite side of the injection nozzle). Note that, although not particularly limited, FIGS. 1 to 4 are views (top views) of the injection device 1 mounted on machine base of various molding machines as viewed from above.

Note that, when the pressure holding device 3 is disposed on the upper side of the injection cylinder 11, the pressure holding device 3 is in a position relationship in which the pressure holding device 3 rises directly in front of the mold, and workability such as molding deteriorates. Therefore, the pressure holding device 3 is preferably arranged substantially horizontally on a side (side surface side) of the injection cylinder 11. Similarly, the shutoff device 2 is preferably arranged substantially horizontally on the side of the injection cylinder 11.

The injection screw 12 is rotatably supported (held) inside the injection cylinder 11. The injection screw 12 is movable forward and backward with respect to the injection cylinder 11 by the operation of the drive cylinder 14. In addition, a hopper (not illustrated) that supplies a resin material is connected to the injection cylinder 11, and the resin material is supplied from the hopper to the inside of the injection cylinder 11. The injection cylinder 11 is set to a high temperature equal to or higher than the melting point of the resin material in order to melt the resin material in a solid state accommodated between the inner wall of the injection cylinder 11 and the groove of the injection screw 12.

A screw head 12a is provided at the tip of the injection screw 12. The injection screw 12 heats the resin material in a solid state inside the injection cylinder 11 by rotation to bring the resin material into a molten state (plasticizes the resin material). In the metering step of the injection molding step, the injection screw 12 moves back while filling (charging) the molten resin material in front of the screw head 12a. Then, after the filling of the resin material is completed, in the injection step of the injection molding step, the injection screw 12 moves forth in a non-rotating state by the drive cylinder 14, so that the molten resin material is injected.

An injection cylinder head 15 is provided at the tip of the injection cylinder 11 (the side facing the hot runner 50). A resin path 4 is formed inside the injection cylinder head 15, and an injection nozzle 13 is connected to a tip of the injection cylinder head 15. The injection nozzle 13 is connected to the sprue 51 of the hot runner 50. The resin path 4 communicates with the cavity (molding space) of the mold 60 for injection molding via a resin path (runner) inside the hot runner 50.

The shutoff device 2 is disposed between the injection screw 12 and the injection nozzle 13 of the injection cylinder head 15. A pressure holding path 5 communicating with the resin path 4 is branched and formed between the shutoff device 2 of the injection cylinder head 15 and the injection nozzle 13. The pressure holding path 5 is formed to be inclined obliquely rearward (right side in the drawing) with respect to the resin path 4 (or the front surface of the hot runner 50), and an end portion on a side opposite to the resin path 4 is connected to the pressure holding device 3. The pressure of the resin filled in the cavity of the mold 60 can be held by driving the pressure holding device 3 via the resin path of the hot runner 50, the pressure holding path 5, and the resin in the resin path 4.

The shutoff device 2 includes a shutoff plunger 21 that moves back and forth in a direction orthogonal to the resin path 4 (vertical direction in the drawing) to block the resin path 4, and a shutoff cylinder (shutoff actuator) 22 that drives the shutoff plunger 21 to move back and forth with respect to the resin path 4. The shutoff cylinder 22 is connected to the injection cylinder 11 (specifically, the injection cylinder head 15), and a piston rod 22a connected to the shutoff plunger 21 is supported inside a cylinder barrel (cylinder tube) 22b so as to be movable forward and backward via a piston 22c.

Pressure oil is supplied to the cylinder barrel 22b of the shutoff cylinder 22 and is discharged from the cylinder barrel 22b of the shutoff cylinder 22, so that the piston rod 22a is driven to move back and forth in the shutoff cylinder 22. Thus, the shutoff plunger 21 connected to the piston rod 22a moves forward and backward with respect to the resin path 4. In the closed state of the shutoff device 2, the shutoff plunger 21 moves forth toward the resin path 4, so that the resin path 4 on the front side (hot runner 50 side) of the screw head 12a is closed and the connection with the injection nozzle 13 is blocked. On the other hand, in the open state of the shutoff device 2, the shutoff plunger 21 moves back from the resin path 4, so that the resin path 4 on the front side of the screw head 12a is connected to the injection nozzle 13.

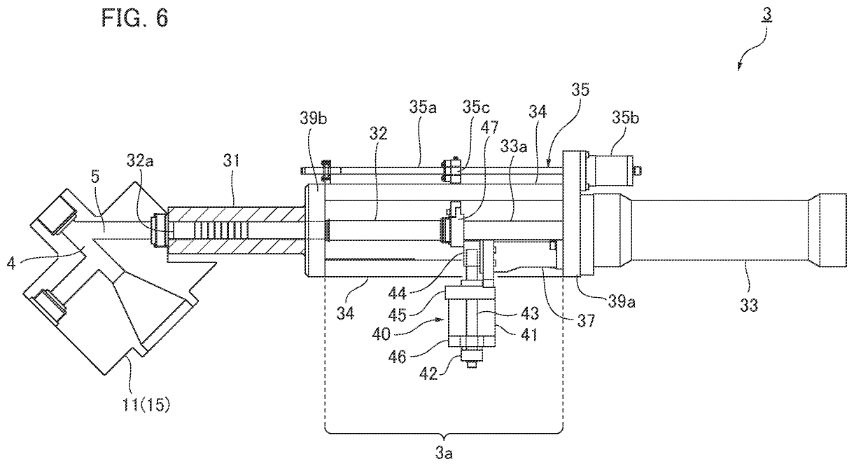

The tip of the pressure holding device 3 is connected between the injection nozzle 13 of the injection cylinder head 15 and the shutoff device 2. As illustrated in FIGS. 1 to 6, the pressure holding device 3 includes a pressure holding device tip portion (pressure holding path forming member) 31 connected to the injection cylinder 11 (specifically, the injection cylinder head 15), a pressure holding plunger (pressure holding plunger) 32, and a pressure holding cylinder (pressure holding actuator or pressure holding cylinder) 33. The tip portion 32a of the pressure holding plunger 32 moves forward and backward in an axial direction (left and right direction in FIGS. 5 and 6) along the cylindrical pressure holding device tip portion 31 and the pressure holding path 5 of the cylinder head 15.

The pressure holding cylinder 33 is fixed to the first supporting member 39a, and the pressure holding device tip portion 31 is fixed to the second supporting member 39b. The first supporting member 39a and the second supporting member 39b are coupled via a plurality of pillars 34. Note that the pressure holding device tip portion 31 and the second supporting member 39b may be integrated.

The pressure holding cylinder 33 is connected to the pressure holding device tip portion 31 via a plurality of pillars 34 extending in the axial direction. Inside the pressure holding cylinder 33, a piston rod 33a connected (coupled) to the end side of the pressure holding plunger 32 is supported so as to be movable forward and backward in the axial direction via a piston 33c. When pressure oil is supplied to the cylinder barrel 33b of the pressure holding cylinder 33, a pressing force is applied to the piston rod 33a of the pressure holding plunger 32, and a discharge path of the pressure oil to the cylinder barrel 33b of the pressure holding piston 33 is opened, so that the pressing force to the pressure holding plunger 32 by the pressure holding cylinder 33 is released (released).

When the pressure holding cylinder 33 applies a pressing force until the pressure holding plunger 32 moves to a movement forward end of the pressure holding path 5, the tip portion 32a of the pressure holding plunger 32 protrudes to the resin path 4. In addition, when the pressing force by the pressure holding cylinder 33 is released, the tip portion 32a of the pressure holding plunger 32 is pressed by the resin material from the resin path 4, and the pressure holding plunger 32 retracts. Thus, the resin material is introduced into the pressure holding path 5 from the resin path 4, and the pressure holding path 5 is filled (charged) with the resin material.

Further, in the pressure holding device 3, the portion where the pillar 34 is disposed constitutes a plunger exposed portion 3a where the pressure holding plunger 32 is exposed to the outside. The plunger exposed portion 3a of the pressure holding device 3 is provided with a potentiometer (a linear potentiometer, a linear sensor, and a position detection device of the pressure holding plunger 32) 35, a stopper member 40, and a protruding member (flange-like member) 47.

The potentiometer 35 includes a shaft 35a, a sensor body 35b, and a position detection plate 35c, and detects the axial position of the pressure holding plunger 32. The shaft 35a of the potentiometer 35 is attached in parallel with the pressure holding plunger 32 and the pillar 34. The position detection plate 35c is fixed to the pressure holding plunger 32, and the shaft 35a is inserted therethrough. The position detection plate 35c moves along the shaft 35a in accordance with the movement of the pressure holding plunger 32. The sensor body 35b detects the position of the position detection plate 35c on the shaft 35a, and outputs a signal indicating the axial position of the pressure holding plunger 32.

The stopper member 40 is attached to a predetermined position of the plunger exposed portion 3a via a frame 37 fixed to the pressure holding cylinder 33 (specifically, the first holding member 39a). The stopper member 40 includes an air cylinder 41, a connecting member 42, a pair of rod members 43, and a stopper body 44.

The air cylinder 41 is sandwiched between a first mounting plate 45 fixed to the frame 37 and a second mounting plate 46. The rod 41a of the air cylinder 41 is inserted through the second mounting plate 46 and extends in a direction away from the pressure holding plunger 32. The tip of the rod 41a of the air cylinder 41 and one end of each rod member 43 are connected by the connecting member 42 extending in parallel with the second mounting plate 46.

Each rod member 43 penetrates the first mounting plate 45 and the second mounting plate 46 and extends in a direction intersecting (or orthogonal to) the extension direction of the pressure holding plunger 32. The stopper body 44 extending in parallel with the first mounting plate 45 is attached to the other end of each rod member 43 so as to face the pressure holding plunger 32. The stopper body 44 is an example of a second engagement member, and can switch between a first position projecting toward the pressure holding plunger 32 and a second position retracted from the pressure holding plunger 32 by expansion and contraction of the rod 41a of the air cylinder 41.

The protruding member 47 is an example of a first engagement member, and is provided on the pressure holding plunger 32 or the piston rod 33a. Preferably, the protruding member 47 is provided at a coupling position between the pressure holding plunger 32 and the piston rod 33a (a position on the substantially terminal side of the pressure holding plunger 32).

The cross-sectional area of the protruding member 47 is formed to be larger than the cross-sectional areas of the pressure holding plunger 32 and the piston rod 33a. Thus, the protruding member 47 can interfere with the stopper body 44 moved (projecting) toward the pressure holding plunger 32. Note that, in the protruding member 47, the position detection plate 35c is preferably connected to a portion where the stopper body 44 does not interfere (for example, a position opposite to a position where the stopper member 40 is provided).

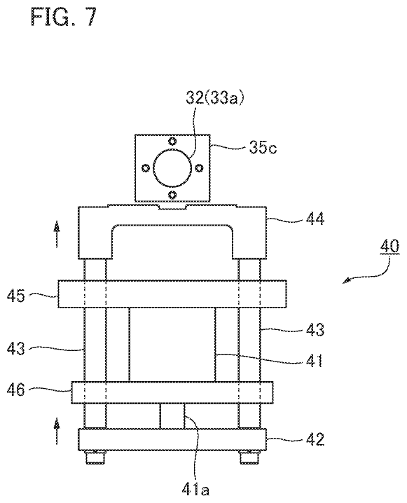

When the rod 41a of the air cylinder 41 extends, the connecting member 42 moves in a direction away from the second mounting plate 46 (lower side in the drawing). Then, the stopper body 44 integrated with the connecting member 42 via the rod member 43 also moves in a direction away from the pressure holding plunger 32, and the stopper body 44 moves to the second position retracted from the pressure holding plunger 32. As illustrated in FIGS. 5 and 7, the stopper body 44 at the second position is located farther away from the pressure holding plunger 32 than the end of the protruding member 47, and allows the protruding member 47 fixed to the pressure holding plunger 32 or the piston rod 33a to move in the axial direction.

On the other hand, when the rod 41a of the air cylinder 41 contracts, the connecting member 42 moves in a direction approaching the second mounting plate 46 (upper side in the drawing). Then, the stopper body 44 integrated with the connecting member 42 via the rod member 43 also moves in a direction approaching the pressure holding plunger 32, and the stopper body 44 moves to the first position projecting toward the pressure holding plunger 32. As illustrated in FIG. 6, the stopper body 44 at the first position is at a position interfering with the protruding member 47. Thus, the stopper body 44 at the first position engages with the protruding member 47 when the pressure holding plunger 32 moves back from the movement forward end, and restricts the retraction amount of the pressure holding plunger 32. Note that the position of the stopper member 40 in the axial direction of the pressure holding plunger 32 is determined according to the filling amount of the resin material in the pressure holding path 5.

Next, the operation of the injection device 1 will be described with reference to FIGS. 1 to 4.

FIG. 1 illustrates a state at the start of injection of the injection device 1. The shutoff device 2 in FIG. 1 is in an open state in which the shutoff plunger 21 is retracted from the resin path 4. In addition, in the pressure holding device 3 in FIG. 1, the pressing force of the pressure holding piston 33 is released, and the pressure holding plunger 32 is in a state of being freely movable in the axial direction. Accordingly, the tip portion 32a of the pressure holding plunger 32 can be moved back from the position of the movement forward end. Further, the position detection plate 35c of the pressure holding plunger 32 is located closer to the pressure holding path 5 than the position of the stopper member 40, and the stopper member 40 of the pressure holding device 3 is in the first position where the stopper body 44 projects from the pressure holding plunger 32. In addition, in the example of FIG. 1, ensuring of the molten resin material required in one injection operation (metering step, charge) is completed.

In the state of FIG. 1, the injection screw 12 moves forth in a non-rotating state by the drive cylinder 14, so that the molten resin material is injected from the injection nozzle 13 into the mold 60 via the hot runner 50 (injection step). At this time, the resin in the resin path 4 flows into the pressure holding path 5, the pressure holding plunger 32 is pushed back (that is, it is pushed to the side of the pressure holding cylinder 33), and the resin material for pressure holding is filled in the pressure holding path 5. The amount of the resin material for pressure holding (volume or weight) measured (filled) above at least corresponds to an amount of the resin material (thermoplastic resin) introduced into the mold 60, the amount being cooled and shrunk by contact with the mold 60 during the secondary pressure holding step (described later).

Since the pressure holding plunger 32 is in a free state, the pressure holding plunger 32 moves back in the pressure holding path 5 by the pressing force of the resin flowing from the resin path 4, but as illustrated in FIG. 2, the protruding member 47 is engaged with the stopper body 44 at the first position, so that the pressure holding plunger 32 stops and does not further move back. Thus, the pressure holding device 3 can fill the pressure holding path 5 with an appropriate amount of the resin material for pressure holding.

After the inside of the mold 60 is filled with the resin, the driving position (pressurized state) of the drive cylinder 14 is maintained for a predetermined time. The resin material in the resin path 4 is introduced into the cavity of the mold 60 by the pressurization of the injection screw 12, and the pressure of the resin material in the cavity is held (primary pressure holding step).

Thereafter, as illustrated in FIG. 2, the shutoff plunger 21 of the shutoff device 2 moves forth toward the resin path 4, and the shutoff device 2 is closed. In the pressure holding device 3, the pressure holding plunger 32 is pressurized by the driving of the pressure holding cylinder 33. Then, as the resin material in the pressure holding path 5 flows toward the side of the resin path 4, an appropriate amount of resin for pressure holding is additionally introduced into the cavity, and the pressure of the resin material in the cavity is held (secondary pressure holding step). On the other hand, in the space on the side of the injection screw 12 in which the connection with the resin path 4 is shutoff by the shutoff device 2, the pressure of the drive cylinder 14 is released and the injection screw 12 moves back while rotating, and the resin material metering step for the next injection is started.

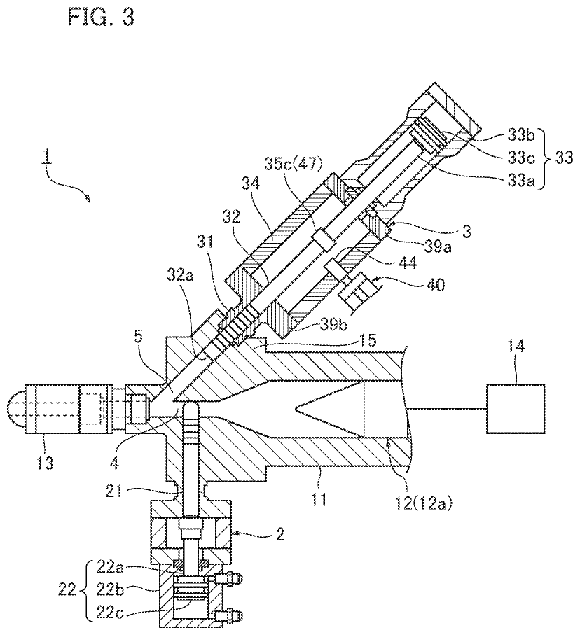

When the secondary pressure holding by the pressure holding device 3 is completed, as illustrated in FIG. 3, the pressing force of the pressure holding cylinder 33 is reduced to be lower than that at the time of holding the pressure, and the pressure holding plunger 32 of the pressure holding device 3 is moved back. Thus, the internal pressure of the hot runner 50 (further, the resin path 4 and the pressure holding path 5) is released (the resin material in each resin path is depressurized). In FIG. 3, the stopper member 40 of the pressure holding device 3 is in the second position where the stopper body 44 is retracted with respect to the pressure holding plunger 32. Therefore, the pressure holding plunger 32 can move back beyond the position of the stopper member 40. That is, as compared with the internal volume of the pressure holding path (total volume of the space of the resin path 4 on the front side (the side of the hot runner 50) divided by the resin path inside the hot runner 50, the pressure holding path 5, and the shutoff plunger 21) at the time of filling the resin material for pressure holding (specifically, for secondary pressure holding), the internal volume of the pressure holding path increases at the time of pressure release, and it is possible to sufficiently release the pressure of the resin.

During the pressure holding step, since a high pressure is applied to the molten resin material, the resin material is introduced into the cavity of the mold 60 in a state of being slightly compressed (the volume is slightly reduced) from that at the time of the injection step. Therefore, the volume of the resin material increases at the time of pressure release, and as the resin path inside the hot runner 50 is longer and the total volume of the resin path is larger, the volume of the resin material increases at the time of pressure release, and the movement backward amount of the pressure holding plunger 32 increases. In the pressure holding device 3 and the pressure holding method of the present embodiment, the capacity of the resin path (volume inside the pressure holding path) can be changed by the protruding member 47 and the stopper member 40. In the present embodiment, the total volume of the resin path can be increased at the time of pressure release as compared with the time of the injection step, and the moving amount of the pressure holding plunger 32 can be increased, so that the pressure of the resin material after the pressure holding can be sufficiently released without increasing the size of the pressure holding device 3.

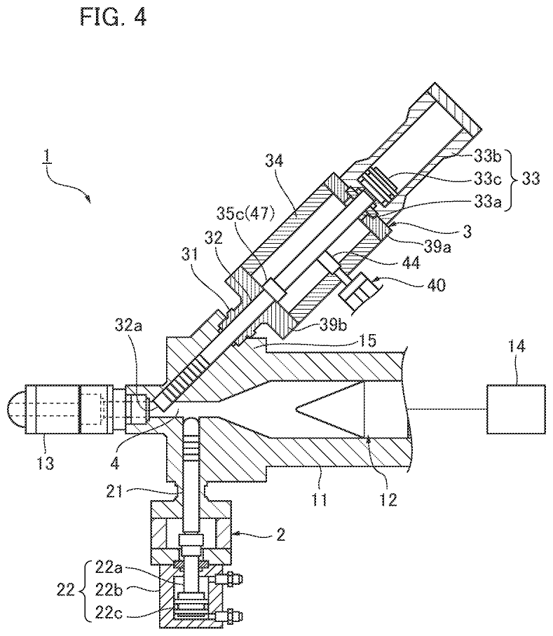

Thereafter, as illustrated in FIG. 4, the shutoff plunger 21 of the shutoff device 2 moves back from the resin path 4, and the space on the injection screw 12 side and the resin path 4 are connected again. Then, the pressing force is applied again to the pressure holding plunger 32 by the pressure holding cylinder 33, and the pressure holding plunger 32 is moved forth until the tip portion 32a projects to the resin path 4. Thus, the resin material in the pressure holding path 5 is discharged to the resin path 4. Further, the stopper member 40 of the pressure holding device 3 is switched to the state of the first position where the stopper body 44 projects with respect to the pressure holding plunger 32. Thus, the operation of the injection device 1 for one cycle is completed.

### <Injection Molding Flow Including Pressure Holding Step of Present Embodiment>

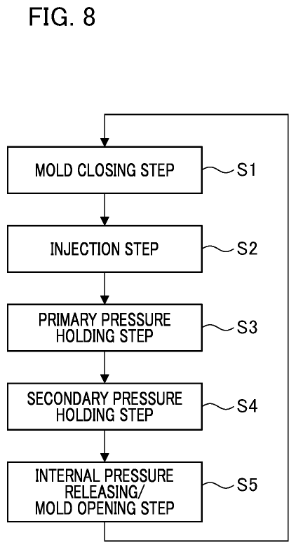

FIG. 8 is a diagram illustrating a molding flow in an injection molding apparatus including the injection device of the present embodiment.

First, in the injection molding apparatus, the mold 60 is closed (S1). At this stage, the injection device 1 is in the state at the start of injection illustrated in FIG. 1, and the injection device 1 completes the ensuring of the molten resin material (metering step, charge) required in one injection operation.

In the injection step (S2), in the injection device 1, the injection screw 12 moves forth in a non-rotating state by the drive cylinder 14, and the molten resin material is injected from the injection nozzle 13 into the mold 60 via the hot runner 50.

In the injection device 1 in the injection step, the resin in the resin path 4 flows into the pressure holding path 5, the pressure holding plunger 32 is pushed back, and the pressure holding path 5 is filled with the resin material for pressure holding. At this time, the protruding member 47 is engaged with the stopper body 44 at the first position to stop the pressure holding plunger 32, and the resin material for pressure holding is filled in the pressure holding path 5 in an appropriate amount.

In the primary pressure holding step (S3), after the inside of the mold 60 is filled with the resin, the pressurized state of the drive cylinder 14 is maintained for a predetermined time in the injection device 1, and a resin material having a volume contracted by cooling is introduced into the cavity of the mold 60. Thus, the pressure of the resin material in the cavity of the mold 60 is held via the resin path of the hot runner 50, the resin path 4, and the pressure holding path 5.

In the secondary pressure holding step (S4), in the injection device 1, the shutoff plunger 21 of the shutoff device 2 moves forth toward the resin path 4, and the shutoff device 2 is closed. In the pressure holding device 3, the pressure holding plunger 32 is pressurized by the driving of the pressure holding cylinder 33, the resin material is introduced into the cavity of the mold 60, and the resin material in the cavity of the mold 60 is held via the resin path of the hot runner 50, the resin path 4, and the pressure holding path 5. At this time, in the space on the injection screw 12 side of the injection device 1, the pressure of the drive cylinder 14 is released and the injection screw 12 moves back while rotating, and the resin material metering step for the next injection is started.

After completion of the secondary pressure holding, an internal pressure releasing step is performed (S5). The injection device 1 in the internal pressure releasing step reduces the pressing force of the pressure holding cylinder 33 to be lower than that at the time of holding the pressure, and moves back the pressure holding plunger 32 of the pressure holding device 3. At this time, the stopper member 40 of the pressure holding device 3 is in the second position where the stopper body 44 is retracted with respect to the pressure holding plunger 32, and the pressure holding plunger 32 can be moved back beyond the position of the stopper member 40. Thus, the pressure of the resin material in the resin path of the hot runner 50 and the resin path 4 and the pressure holding path 5 is released.

Thereafter, in the injection device 1, as illustrated in FIG. 4, the shutoff plunger 21 of the shutoff device 2 moves back from the resin path 4, and the space on the injection screw 12 side and the resin path 4 are connected again. Then, the pressing force is applied again to the pressure holding plunger 32 by the pressure holding cylinder 33, and the pressure holding plunger 32 is moved forth until the tip portion 32a projects to the resin path 4. Further, the stopper member 40 of the pressure holding device 3 is switched to the state of the first position where the stopper body 44 projects with respect to the pressure holding plunger 32.

After completion of the pressure release step, the mold 60 is opened, and the injection molded article (preform) is carried out.

By repeating the above steps S1 to S5, the injection molding apparatus can produce a molded article in a continuous cycle.

### <Reinforcing Mechanism of Pressure Holding Device 3>

In the pressure holding device 3, the pressure holding device tip portion 31 (fixed end) is fixed (screwed) to the injection cylinder head 15 and supported in a cantilever state. The weight of the pressure holding device 3 is equal to or more than several tens kg, and in the case of the pressure holding device 3 having a large size capable of using a large amount of resin for pressure holding, the weight may exceed 100 kg. Therefore, the pressure holding device 3 may be bent by its own weight and the free end side (cylinder barrel 33b side) may hang down only by fixing the configuration of FIG. 1 and the like.

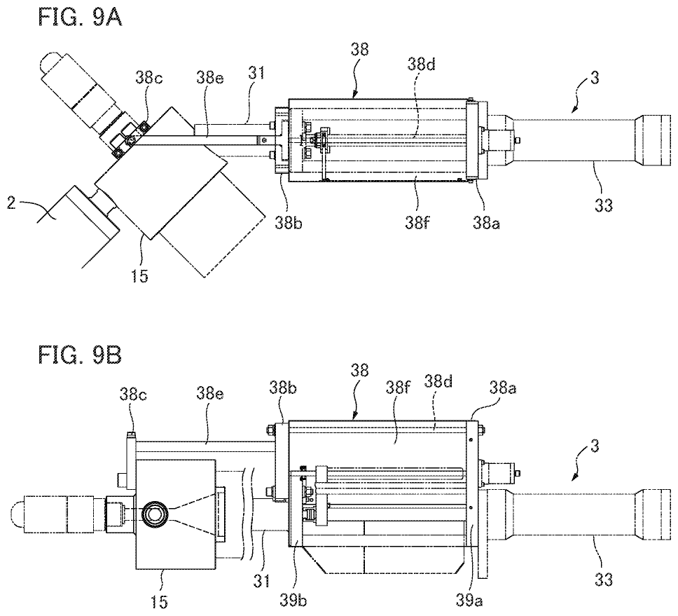

In addition, the vibration of the molding machine or the injection cylinder 11 is also transmitted to the pressure holding device 3, so that the free end side of the pressure holding device 3 may swing greatly or sag easily. When the free end side of the pressure holding device 3 hangs down, there is a high possibility that the pressure holding device 3 cannot be operated with high accuracy and is damaged. In order to prevent this, a reinforcing member (sag preventing member) 38 as illustrated in FIGS. 9A and 9B may be provided in the pressure holding device 3 (or the injection device 1).

The reinforcing member 38 includes at least a first plate-shaped member 38a fixed to the first supporting member 39a, a second plate-shaped member 38b fixed to the first supporting member 39b, a third plate-shaped member 38c fixed to the injection cylinder head 15 of the injection device 1, a first rod-shaped member 38d coupling the first plate-shaped member 38a and the second plate-shaped member 38b, and a second rod member 38e coupling the second plate-shaped member 38b and the third plate-shaped member 38c. Further, a cover member 38f may be provided between the first plate-shaped member 38a and the second plate-shaped member 38b. Each of the above members constituting the reinforcing member 38 is provided at a position above the pressure holding device 3 and the injection cylinder head 15 (a position in a direction opposite to a direction in which a free end hangs down, a position in anti-gravity direction).

By the reinforcing member 38 extending from the injection nozzle head 15, the free end side of the pressure holding device 3 is stretched and supported in the anti-gravity direction, and sagging and deflection of the pressure holding device 3 can be suppressed. Note that, in order to reduce the occupied space (lateral width) of the pressure holding device 3 in the horizontal direction and improve the workability, it is preferable that the members such as the potentiometer 35 and the reinforcing member 38 are disposed on the upper side of the pressure holding device 3 and the stopper member 40 is disposed on the lower side.

<Molding Apparatus on which Pressure Holding Device 3 is Mounted>

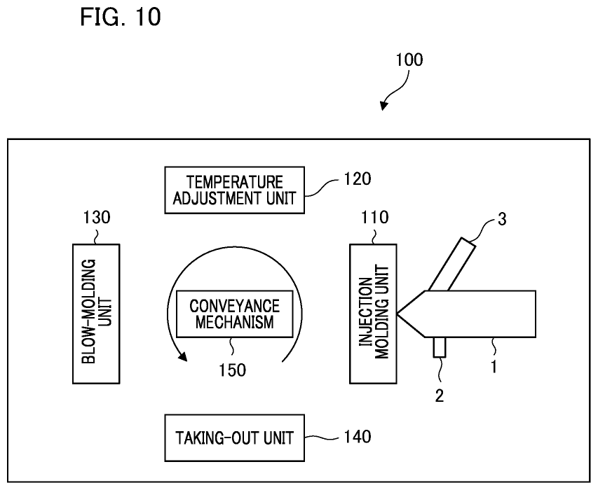

The pressure holding device 3 of the above embodiment can be mounted on, for example, a molding device illustrated in the following FIGS. 10 to 12. Note that the molding device described below is merely an example, and the pressure holding device 3 of the above embodiment may be mounted on a molding device other than those illustrated in FIGS. 10 to 12.

FIG. 10 illustrates a configuration example of a one-stage type blow-molding apparatus. The one-stage type blow-molding apparatus blow-molds a container by utilizing residual heat (internal heat quantity) from injection molding without cooling a preform to room temperature.

A blow-molding apparatus 100 illustrated in FIG. 10 includes, for example, four molding stations, and specifically includes an injection molding unit 110 that performs injection molding of a preform, a temperature adjustment unit 120 that adjusts the temperature of the preform, a blow-molding unit 130 that performs blow molding of the preform after the temperature adjustment, and a taking-out unit 140 that takes out a blow-molded container. The four molding stations are arranged at positions rotated by a predetermined angle (for example, 90 degrees) around a conveyance mechanism 150.

The conveyance mechanism 150 includes a transfer plate (not illustrated) that rotates about an axis in a direction perpendicular to the paper surface of FIG. 10. The conveyance mechanism 150 carries the preform or the container held by a neck mold between the molding stations by moving the transfer plate in the order of the injection molding unit 110, the temperature adjustment unit 120, the blow-molding unit 130, and the taking-out unit 140.

In the blow-molding apparatus of FIG. 10, the injection molding unit 110 includes a cavity mold, a core mold, a neck mold (also collectively referred to as an injection molding mold), and a hot runner mold. The injection molding unit 110 is connected to the injection device 1 including the pressure holding device 3 of the present embodiment. The pressure holding device 3 supplies a resin material (for example, PET) to a cavity (molding space) of an injection molding mold via a hot runner mold to retain pressure. Note that the resin material is introduced from the injection device 1 into the closed mold in the injection molding unit 110, and injection molding of the preform is performed.

The preform manufactured by the injection molding unit 110 is conveyed to the temperature adjustment unit 120 and subjected to temperature adjustment for bringing the temperature close to a temperature suitable for final blow. Thereafter, the preform whose temperature has been adjusted is conveyed to the blow-molding unit 130 in a state of having residual heat from injection molding, and shaped into a container by blow molding using a blow mold. The blow-molded container is conveyed to the taking-out unit 140 and taken out of the apparatus.

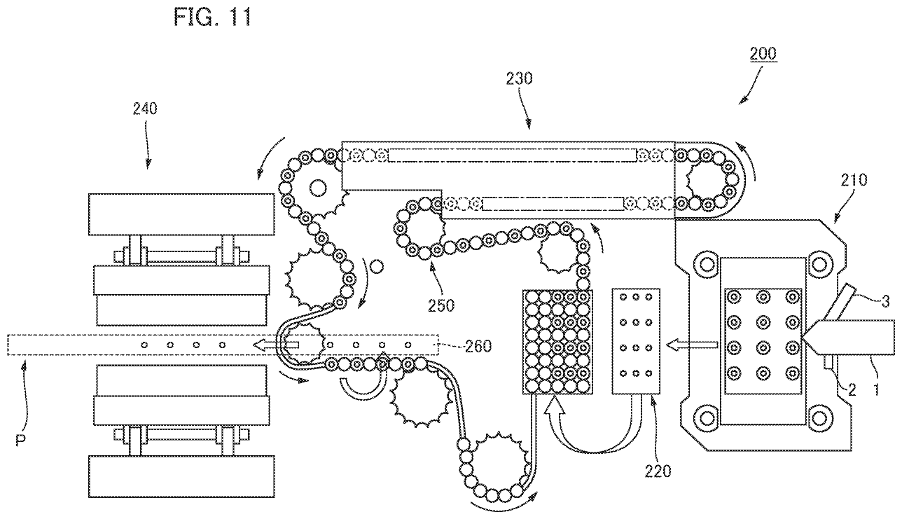

FIG. 11 illustrates a configuration example of a 1.5 stage type blow-molding apparatus having both the advantages of the hot parison type and the cold parison type. In the 1.5 stage blow molding method, a preform having residual heat from injection molding is basically blow-molded to manufacture a container similarly to the hot parison method (one-stage type). However, the cycle of the blow molding in the 1.5 stage method is set to be shorter than the cycle of the injection molding of the preform. The plurality of preforms molded in one injection molding cycle are blow-molded in a plurality of blow-molding cycles (for example, three times).

As illustrated in FIG. 11, the blow-molding apparatus 200 includes an injection molding unit 210 that performs injection molding of a preform, a cooling unit 220 that cools the preform, a heating unit 230 that heats the cooled preform, and a blow-molding unit 240 that blow-molds the heated preform. Further, the blow-molding apparatus 200 includes a continuous conveyance unit 250 that conveys the preform carried out from the cooling unit 220 to the blow-molding unit 240 via the heating unit 230.

In the blow-molding apparatus of FIG. 11, the injection molding unit 210 includes a cavity mold, a core mold, a neck mold (also collectively referred to as an injection molding mold), and a hot runner mold. The injection molding unit 210 is connected to the injection device 1 including the pressure holding device 3 of the present embodiment. The pressure holding device 3 supplies a resin material (for example, PET) to a cavity (molding space) of an injection molding mold via a hot runner mold to retain pressure. Note that the resin material is introduced from the injection device 1 into the closed mold in the injection molding unit 210, and injection molding of the preform is performed.

The preform injection-molded by the injection molding unit 210 is supplied from the injection molding unit 210 to the cooling unit 220. The cooling unit 220 forcibly cools the preform molded by the injection molding unit 210. The preform is transferred from the cooling unit 220 in a state of being cooled to a predetermined temperature, and is continuously conveyed along the conveying line of the continuous conveyance unit 250. The preform conveyed by the continuous conveyance unit 250 passes through the heating unit 230 and is heated to an appropriate stretching temperature by the heating unit 230.

The preform heated by the heating unit 230 is delivered from the continuous conveyance unit 250 to an intermittent conveyance unit 260, and is conveyed to the blow-molding unit 240 at predetermined intervals. The blow-molding unit 240 stretch-blow-molds a predetermined number of preforms to manufacture a container. The container manufactured by the blow-molding unit 240 is conveyed to a taking-out position P outside the blow-molding unit 240 by the intermittent conveyance unit 260 and taken out to the outside of the apparatus.

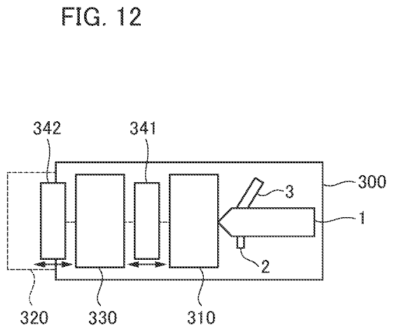

FIG. 12 illustrates a configuration example of a two-stage injection molding apparatus 300 that does not include a blow-molding unit. The injection molding apparatus 300 includes an injection molding unit 310, a taking-out unit 320, a cooling unit 330, and a conveyance mechanism. The cooling unit 330 includes a cooling pot (not illustrated) that accommodates the preform and cools a body portion of the preform from the outside, and a cooling rod (not illustrated) that is inserted into a hollow portion of the body portion of the preform and cools the body portion from the inside. The conveyance mechanism includes a first holding member 341 that conveys the preform from the injection molding unit 310 to the cooling unit 330, and a second holding member 342 that conveys the preform from the cooling unit 330 to the taking-out unit 320. The injection molding unit 310 is provided with a cavity mold, a core mold, a neck mold (also collectively referred to as an injection molding mold), and a hot runner mold. The injection molding unit 310 is connected to the injection device 1 including the pressure holding device 3 of the present embodiment. The pressure holding device 3 supplies a resin material (for example, PET) to a cavity (molding space) of an injection molding mold via a hot runner mold to retain pressure.

In the injection molding apparatus 300, a resin material (for example, PET) is introduced from the injection device 1 into a closed mold in the injection molding unit 310, and injection molding of a preform is performed. Thereafter, the preform released in a high temperature state (for example, a state where the outer surface of the body portion is 100 to 130° C.) is conveyed to the cooling unit 330. The cooling unit 330 cools the preform to such an extent that shrinkage deformation such as sink marks does not occur even when the preform is left at room temperature (for example, the outer surface of the body portion is in a state of 50 to 60° C. or lower). Next, the sufficiently cooled preform is conveyed to the taking-out unit 320 and taken out to the outside of the apparatus.

Hereinafter, functions and effects of the present embodiment will be described.

The injection device 1 of the present embodiment includes the stopper member 40 that restricts the movement backward amount of the pressure holding plunger 32 in the pressure holding device 3. When the pressure holding path 5 is filled with the resin material, the stopper body 44 (second engagement member) of the stopper member 40 restricts the movement backward amount of the pressure holding plunger 32 at the first position engaged with the protruding member 47 (first engagement member). Thus, the pressure holding path 5 can be filled with an appropriate amount of the resin material for pressure holding. In addition, since the variation in the filling amount of the pressure holding resin is suppressed by the stopper member 40, the injection molding conditions (a V-P switching position of the molten resin to be injected (the switching position between the speed control and the pressure control) and the like) set for the operation of the injection screw 12 function well, it is possible to avoid an overpack and the like, variation in the filling amount, and the like, and it is easy to keep the quality of the injection molded article uniform.

On the other hand, when the pressure of the mold is released after the pressure holding, the stopper body 44 moves from the first position to the retracted second position to release the restriction on the movement backward amount of the pressure holding plunger 32. Thus, the internal volume of the pressure holding path at the time of pressure release is larger than the internal volume of the pressure holding path at the time of filling the resin material for pressure holding. Therefore, for example, even for the hot runner 50 having a large volume in the resin path, for such as a mold having an open gate type gate structure or a mold having a three-row resin path, it is possible to sufficiently release the pressure of the mold after holding the pressure. Thus, the resin material constituting the gate portion at the bottom of the preform and the resin material in the nozzle portion of the hot runner 50 are separated from each other, the resin material at the gate portion is sufficiently solidified, and the preform can be appropriately released from the mold.

If the pressure of the resin in the resin path in the hot runner 50 cannot be sufficiently released after the pressure holding step, solidification of the resin material in the cavity-mold gate hole (first narrowed portion) communicating with the hot runner 50 is hindered. Thus, defective molding of cobwebbing occurs at the gate portion of the bottom portion of the preform. In addition, if the gate portion of the preform cannot be appropriately solidified, the resin material stays in a state of being inappropriately solidified in the nozzle portion (second narrowed portion) of the hot runner 50 communicating with the gate hole of the cavity mold 60, and the nozzle portion of the hot runner 50 is clogged.

Further, in the present embodiment, since the internal volume of the pressure holding path at the time of pressure release can be increased without increasing the internal volume of the pressure holding path at the time of filling the resin material for pressure holding, the effect of shortening the molding cycle is not reduced.

In the present embodiment, the first engagement member and the stopper member 40 are provided on the plunger exposed portion 3a of the pressure holding device 3 where the pressure holding plunger 32 is exposed to the outside. Therefore, it is also easy to retrofit the first engagement member and the stopper member 40 to the conventional pressure holding device.

Further, in the present embodiment, the stopper body 44 is engaged with the pressure holding plunger 32 or the protruding member 47 to restrict the movement backward amount of the pressure holding plunger 32. Therefore, as compared with the configuration of the conventional pressure holding device 3, it is not necessary to attach an additional component to the pressure holding plunger 32, so that an increase in device cost can be suppressed. Furthermore, it is not necessary to change the size of the pressure holding device 3 (pressure holding cylinder 33 and the pressure holding plunger 32) to a large size only to ensure the volume in the pressure holding path at the time of pressure release, and an increase in device cost can also be suppressed.

The present invention is not limited to the above embodiment, and various improvements and design changes may be made without departing from the gist of the present invention.

For example, the injection molded article manufactured by applying the injection device of the present invention is not limited to the preform, and the injection device may be applied to manufacture other molded articles.

In addition, the embodiments disclosed herein are to be considered in all respects as illustrative and not restrictive. The scope of the present invention is indicated not by the above description but by the claims, and it is intended that meanings equivalent to the claims and all modifications within the scope are included.

1. A pressure holding device attached to a pressure holding path branching from a resin path of an injection device and configured to hold a pressure in the resin path and a pressure in the pressure holding path after injection of a resin material into a mold, the pressure holding device comprising:
a pressure holding plunger having an outer periphery to which a first engagement member is fixed, the pressure holding plunger moving forward and backward in the pressure holding path;
a pressure holding actuator that drives the pressure holding plunger; and
a stopper member that restricts a movement backward amount of the pressure holding plunger, wherein
the stopper member includes:
a second engagement member that engages with the first engagement member; and
a drive member that moves the second engagement member forward and backward in a direction intersecting a moving direction of the pressure holding plunger,
when the pressure holding path is filled with the resin material, the second engagement member restricts the movement backward amount of the pressure holding plunger at a first position where the second engagement member is engaged with the first engagement member, and
when a pressure of the mold is released after pressure holding, the second engagement member moves from the first position to a second position retracted from the first position to release a restriction on the movement backward amount of the pressure holding plunger.

2. The pressure holding device according to claim 1, wherein
the first engagement member and the stopper member are provided in a plunger exposed portion of the pressure holding device where the pressure holding plunger is exposed to the outside.

3. The pressure holding device according to claim 1, further comprising
a potentiometer that detects a position of the pressure holding plunger, wherein
the first engagement member is a member of the potentiometer fixed to the pressure holding plunger.

4. An injection device comprising:
an injection cylinder including a resin path through which a resin material is injected into a mold and a pressure holding path branching from the resin path; and
the pressure holding device according to claim 1 attached to the pressure holding path.

5. A method for injecting a resin material using the injection device according to claim 4, the method comprising:
injecting a resin material into the mold via the resin path and filling the pressure holding path with the resin material;
holding a pressure of the resin path and a pressure of the pressure holding path by the pressure holding device after the injecting of the resin material and the filling of the pressure holding path; and
reducing a pressing force of the pressure holding device to be lower than a pressing force at a time of holding a pressure to release a pressure of the mold after the holding of the pressure of the resin path and the pressure of the pressure holding path, wherein
during the injecting of the resin material and the filling of the pressure holding path, the second engagement member is arranged at a first position where the second engagement member is engaged with the first engagement member to restrict the movement backward amount of the pressure holding plunger, and
during the reducing of the pressing force of the pressure holding device, the second engagement member is arranged at a second position retracted from the first position to release a restriction on the movement backward amount of the pressure holding plunger.
